(19) United States
(12) Patent Application Publication
(10) Pub. No.: US 2007/0054168 A1
(43) Pub. Date: Mar. 8, 2007

(54) Zinc/air cell

(76) Inventors: Hao Chang, Bethel, CT (US); Michael Brovarski, Monroe, CT (US); Steven J. Specht, Brookfield, CT (US); David L. Pappas, Danbury, CT (US)

Correspondence Address: MR. BARRY D. JOSEPHS;ATTORNEY AT LAW, 19 NORTH STREET, SALEM, MA, 01970, US

(21) Appl. No.: 11/220,269

(22) Filed: Sep. 6, 2005

(51) Int. Cl. H01M 12/06; H01M 2/12

(52) U.S. Cl. 429/27; 429/82; 429/87

(57) ABSTRACT

A zinc/air button cell having an air spacer member within the air inlet space of the cathode can. The spacer member may be of solid plastic, rubber, or metal construction inserted into the air inlet space (plenum region) of the cathode can adjacent air holes in the can. The spacer member may be of disk-like configuration with cut out sections therein of varying configurations. The cut out sections in the spacer disk form channels of unoccupied free space underlying the air holes allowing air to pass unobstructed from the air holes to the cathode assembly. The channels of free space are generally much wider than the diameter of the air holes. The wide channels of unoccupied “free space” running between the air holes and cathode assembly improve air flow distribution to the cathode assembly. The spacer disk simultaneously provides sufficient support to the cathode assembly preventing it from bending into the cathode can air inlet space.

### FIELD OF THE INVENTION

The invention relates to a metal/air cell preferably having an anode comprising zinc and an air cathode. The invention relates to a metal/air cell having an anode comprising zinc and an air cathode with spacer member of varying shape and structure within the air inlet space between cathode can and cathode assembly to facilitate air diffusion.

### BACKGROUND

Zinc/air depolarized cells are typically in the form of miniature button cells which have particular utility as batteries for electronic hearing aids including programmable type hearing aids. Such miniature cells typically have a disk-like cylindrical shape of diameter between about 4 and 20 mm, typically between about 4 and 16 mm and a height between about 2 and 9 mm, preferably between about 2 and 6 mm. Zinc air cells can also be produced in somewhat larger sizes having a cylindrical casing of size comparable to conventional AAAA, AAA, AA, C and D size Zn/MnO₂ alkaline cells and even larger sizes.

The miniature zinc/air button cell typically comprises an anode casing (anode can), and a cathode casing (cathode can). The anode casing and cathode casing each have a closed end an open end and integral side walls extending from the closed end to the open end. The anode casing is fitted with an insulating seal ring which tightly surrounds the anode casing side wall. Anode material is inserted into the anode casing and air diffuser, electrolyte barrier material, and cathode assembly are inserted into the cathode casing. After the necessary materials are inserted into the anode and cathode casings, the open end of the cathode casing is typically pushed over the open end of the anode casing during assembly so that a portion of the cathode casing side walls covers a portion of the anode casing side wall with insulating seal therebetween. The anode and cathode casing are then interlocked in a second step by crimping the edge of the cathode casing over the insulator seal and anode casing. During the crimping procedure (or in a separate step) radial forces are also applied to the cathode casing walls to assure tight seal between the anode and cathode casings.

The anode casing of zinc/air button cells may be filled with a mixture comprising particulate zinc. Typically, the zinc mixture contains mercury and a gelling agent and becomes gelled when electrolyte is added to the mixture. The electrolyte is usually an aqueous solution of potassium hydroxide, however, other aqueous alkaline electrolytes can be used. The closed end of the cathode casing (when the casing is held in vertical position with the closed end on top) may have a flat raised portion near its center. This raised portion forms the positive terminal and typically contains a plurality of air holes therethrough. In this design, the cathode casing closed end also typically has an annular recessed step which surrounds the raised positive terminal. Alternatively, the closed end of the cathode casing may be completely flat across its diameter, that is, without any raised portion at its center. In such design the central portion of such flat area at the closed end of the cathode casing typically forms the cell's positive terminal. In either case, the closed end of the cathode casing of button zinc/air cells is punctured with one or more small air holes to allow air to enter the cell. Such air then traverses an air diffusion layer (or air diffuser) in order to reach the cathode disk.

Catalytic material typically comprising a mixture of particulate manganese dioxide, carbon, and hydrophobic binder can be compacted into a disk shape forming a cathode disk within a cathode assembly. The cathode assembly with cathode disk therein can then be inserted into the cathode casing over the air diffuser on the side of the air diffuser that faces away from the air holes. Typically a cathode assembly is formed by laminating a layer of electrolyte barrier material (hydrophobic air permeable film), preferably Teflon (polytetrafluoroethylene), to one side of the catalytic cathode disk and an electrolyte permeable (ion permeable) separator material to the opposite side of the catalytic cathode disk. The cathode assembly with cathode disk therein is then typically inserted into the cathode casing so that its central portion covers the air diffuser and a portion of the electrolyte barrier layer rests against the inside surface of the step. The cathode disk in the final cell contacts the cathode casing walls around its perimeter.

If the cell is not adequately sealed, electrolyte can migrate around the catalytic cathode assembly and leak from the cathode casing through the air holes. Also electrolyte leakage can occur between the crimped edge of the cathode can and insulator if this area is not tightly sealed. The wall thickness of commercial zinc/air button cells are typically greater than about 6 mil (0.152 mm), for example, between about 6 and 15 mil (0.152 and 0.381 mm). The potential for leakage is greater when the anode casing and cathode casing is of very thin wall thickness, for example, between about 2 and 5 mil (0.0508 and 0.127 mm). Such low wall thickness is desirable, since it results in greater internal cell volume.

After the cell is assembled a removable tab is placed over the air holes on the surface of the cathode casing. Before use, the tab is removed to expose the air holes allowing air to ingress and activate the cell.

The cathode casing typically contains an air diffuser material which covers the inside surface of the cathode casing closed end. That is, the air diffuser material is placed in the air inlet space (plenum space) between the cathode casing closed end and the cathode assembly. If the closed end of the cathode casing has a raised central portion forming the positive terminal contact area, then the air diffuser material underlies such raised central portion. That is, the air inlet space in such design is normally between the raised central portion of the closed end of the cathode casing and the cathode assembly.

The conventional air diffuser serves several purposes. The air diffuser material serves to provide uniform air dispersion within the air inlet space. It can also be composed of electrolyte absorbent material which acts as a blotter to absorb alkaline electrolyte which may leak into the air inlet space. The air diffuser material may provide support for the underlying cathode assembly thus preventing the cathode assembly, which is normally flexible, from bending into the air inlet space (plenum space) or into the air diffusion layer during cell assembly and discharge. Gas pressure buildup during cell usage tends to cause cathode assemblies to bend into the air inlet space unless there is air diffusion material present within such space. Bending of the cathode assembly toward the cathode casing is undesirable since it would block air holes and interfere with proper air diffusion within the air inlet space.

The air diffuser material is normally composed of one or more sheets of air permeable paper or porous cellulosic material. Such permeable paper or porous cellulosic material can also serve as a blotter to absorb trace amounts of electrolyte which may leak into the air inlet space. The air diffuser is normally placed uniformly within the air inlet space (plenum space) between the closed end of the cathode casing and cathode assembly. The air diffuser material fills most or all of such air inlet space and covers the air holes in the closed end of the cathode casing. Commercial button size zinc/air cells which are commonly used in hearing aid devices may have only one air hole or may have a plurality of small air holes, for example, between 2 and 6 air holes and even more depending on cell size.

In some prior art button type zinc/air cells the cathode assembly has a dome shape. That is, they have a convex shape if viewed from the closed end of the cathode casing down into the cathode casing interior, or in other words, away from the air holes. U.S. Pat. Nos. 3,897,265 and 6,087,030 show button zinc/air cells with domed cathode assemblies. Both these references have a porous air diffusion material which fills the air inlet space between the cathode can closed end (adjacent the air holes) and cathode assembly. Such prior art designs may eliminate use of porous diffuser material within the air inlet space, since the domed cathode assembly tends to resist bending and flexing into the air inlet space during cell assembly and cell usage. However, if there is no air diffuser material filling the air inlet space, the domed cathode assemblies are still subject to at least some bending into the air inlet space as gas pressure within the cell builds. Such build up of gas pressure may ultimately cause the domed cathode assembly to bend or push against the air holes and thereby block air flow from these holes. Also domed cathode assemblies are more difficult to fabricate, because of the bending or shaping required during fabrication to form the dome. The domed cathode assembly is also more subject to fracture or cracking during fabrication, particularly if the cathode assembly is intended to be thin.

It is thus desirable to employ flat cathode assemblies which are more economically and reliably fabricated than domed cathode assemblies. However, flat cathode assemblies of desired composition and thickness for use in button size zinc/air cells can gradually bend into the cell's air inlet space thereby obstructing the air holes unless the air inlet space is filled with air diffuser material. U.S. Pat. No. 5,279,905; U.S. Pat. No. 6,602,629 B1; and U.S. Pat. No. 6,830,847 B2 show zinc/air button cells with cathode assemblies having a flat surface abutting the air inlet space of the cathode can and an air diffuser material filling said air inlet space.

Although air diffusers of the prior art that are comprised of paper or cellulosic materials may serve to enhance the dispersion of incoming air, they also tend to slow the rate of air transport directly to the cathode disk, particularly in the regions removed from the holes. This can limit the performance of zinc-air cells in some applications.

Accordingly, it is desirable to provide a configured support material within the air inlet space (plenum space) adjacent air holes in the cathode can of a zinc/air cell, wherein said configured material provides both structural support for the cathode assembly preventing the cathode assembly from bending or penetrating into the air inlet space and also allows for efficient air dispersion into the cathode assembly.

It is desirable to provide a zinc/air cell having a cathode assembly adjacent the air inlet space (plenum space) of the cathode can, wherein there is a configured material within the air inlet space to support the cathode assembly and prevent said cathode assembly from bending into the air inlet space. It is desirable that the cathode assembly have a flat or substantially flat surface facing said air inlet space. It is desirable that the support material be configured to provide channels of unoccupied (free) spaces underlying the air holes so that air may enter the air inlet space and pass freely into the cathode assembly.

It is desirable to position materials of proper configuration within the air inlet space between the cathode assembly and air holes in the cathode can in order to provide enhanced dispersion of incoming air to the cathode assembly.

It is desirable to eliminate any need for using blotter paper within the air inlet space of the cathode can of a zinc/air cell, since the blotter paper retards the rate of transport of incoming air to the cathode assembly.

### SUMMARY OF THE INVENTION

The invention is directed to zinc/air cells, particularly miniature zinc/air cell in the form of button cells. Such miniature button cells typically have a cathode can and an anode can. There is at least one air hole, typically a plurality of air holes running through the closed end of the cathode can. After the anode and cathode components are inserted into the respective cans, the cathode can side walls are crimped over the cathode can side walls with insulator material therebetween. The invention is directed to inserting an air spacer member of varying shape and structure within the air inlet space (plenum region) adjacent the air holes at the closed end of the cathode can.

The miniature zinc/air button cell of the invention typically has a disk-like cylindrical shape of diameter between about 4 and 20 mm, typically between about 4 and 16 mm, and a height between about 2 and 9 mm, preferably between about 2 and 6 mm. The zinc/air cells may have anode can and cathode can wall thickness, typically covering a range between about 2 mil and 15 mil (0.0508 and 0.381 mm). Desirably, the zinc/air cells may have thin anode can and cathode can walls of thicknesses between about 2.0 and 5 mils (0.0508 and 0.127 mm). These wall thicknesses may apply to the thickness of a single layer (unfolded) anode and cathode can side wall and also the thickness of the closed end of the anode and cathode can. When the anode can wall thicknesses are very thin, that is, approaching the lower limit of the above wall thickness ranges, it is preferred to have the anode can side wall once folded in effect forming a double side wall. In such embodiment it will be appreciated that the above wall thickness ranges apply to each one of the double side walls.

In a principal aspect the spacer member of the invention is inserted into the air inlet space (plenum region) located between the inside surface of the closed end of the cathode can and the cathode assembly. There is at least one air hole running through the closed end of the cathode can and typically there are a plurality of air holes. The air spacer member of the invention may be of a disk-like shape and is characterized in that it has one or more apertures or cut out sections therethrough forming individual channels of unoccupied (free) space running through the body of said spacer member. The air spacer member is inserted into the cathode can within the air inlet space (plenum region) so that it abuts the air holes. When the spacer member is inserted into the cathode can, the channels of unoccupied space underlie air holes in the cathode can and provide unobstructed (continuous) channels of unoccupied space between the air holes and cathode assembly (the cathode assembly includes cathode material and one or more electrolyte barrier sheets). The peripheral edge of the spacer member may be circular, noncircular, irregular or jagged depending on the shape and placement of the cut out sections. The thickness of the spacer member, however, is preferably uniform and about equal to the depth of the air inlet space (air inlet plenum region) of the cathode can.

There may also be one or more channels of unoccupied (free) space created around the air spacer member of the invention when it is inserted into the air inlet region of the cathode can and some or all of those unoccupied (free) spaces around the spacer member may be aligned so they underlie at least some of the air holes. The spacer member is positioned so that at least one of the unoccupied channels of free space running through or around said spacer member underlies at least one of the air holes. Typically, there may be a plurality of apertures or cut out sections through the spacer member creating a plurality of channels of unoccupied (free) spaces underlying individual air holes in the cathode can. Preferably there are sufficient numbers of unoccupied channels of free space through or around said spacer member aligned so that said channels of unoccupied free space underlie the majority of the air holes. Preferably the unoccupied channels of free space underlie all of the air holes. Desirably there are individual channels of free space running through or around the spacer member which are aligned with individual air holes so that said channels of free space run uninterrupted (continuous) and preferably perpendicularly between individual air holes and the cathode assembly.

The individual channels of free space running through or around the spacer member of the invention and which underlie the individual air holes in the cathode can are characterized in that they have a diameter which is at least 2 times and desirably between about 2 and 18 times, typically between 2 and 16 times the diameter of the individual air holes in the cathode can. The term “diameter” as used herein shall be interpreted to include the equivalent diameter for non-circular holes or apertures. The equivalent diameter is the diameter which gives the same actual cross sectional area of the hole or aperture as if the cross sectional area is that of a circle. The total channels of free space running through or around the air spacer member of the invention comprises between about 10 and 90 percent, typically between about 50 and 90 percent of the available space in the air inlet region (plenum region) located between the cathode can closed end and cathode assembly before the spacer member is inserted therein. The spacer members of the invention having wide channels of unoccupied (free) space underlying the air holes in the cathode can improves air flow to the cathode assembly thereby improving cell performance and efficiency.

In one aspect the air spacer member of the invention is formed of solid plastic or metal material. The member may be rigid or flexible. The spacer member may also be of durable, compression resistant rubber, for example, styrene-butadiene (SBR) rubber, silicone rubber or equivalent. Preferably the air spacer member is formed of a durable plastic which is durable but resists compression. For example, it may be formed of common plastic materials which resist cold flow (i.e., resist compression when squeezed) such as, but not limited to nylon, high density polyethylene or polypropylene. Since the seal around the cathode assembly is tight, as described the specific embodiments, it is not expected that the spacer member will be exposed to electrolyte leakage. Therefore the spacer member does not specifically have to resist attack by alkaline electrolyte.

The air spacer members of the invention preferably have wide channels of unoccupied (free) space underlying the air holes in the cathode can. Such unoccupied space form continuous channels between individual air holes and the cathode assembly, thereby improving air flow to the cathode assembly. This in turn results in improved cell performance. Simultaneously the spacer member provides sufficient support for the underlying cathode assembly so that the cathode assembly cannot bend or protrude into the air inlet space.

The spacer member of the invention may be of varying shape. The spacer member may be of a disk shape having a plurality of cut out portions therethrough. Spacer member may be in the form of a disk having a plurality of polyhedron or partial polyhedron cut out sections therethrough. The cut out sections may be within the bounds of the circumferential peripheral edge of the disk. The walls of the cut out sections may thus have curvature or they may be straight or substantially straight. In a preferred arrangement the cut out portions are triangular or pyramidal in shape. The spacer disk is placed within the air inlet (plenum region) of the cathode can and registered (positioned) so that the individual cut out sections running through the spacer disk also underlie at least the majority of the individual air holes in the cathode can. Thus, the cut out portions running through the spacer disk form channels of unoccupied (free) space underlying the individual air holes and running uninterrupted (continuous) between the individual air holes and the cathode assembly.

The spacer member of the invention may be a disk shaped member with fingers or leafs jutting out from the center of the disk. Each finger or leaf has an aperture running therethrough. The spacer disk is inserted against the inside surface of the closed end of the cathode can within the air inlet space (plenum region) of the cathode can. The air spacer disk is registered so that the individual apertures running through the fingers in the spacer disk underlie individual air holes in the cathode can. Channels of unoccupied (free) space are thus formed directly under the air holes in the cathode can so that air entering the cathode can passes directly to the cathode assembly. Additionally there are wide channels of unoccupied (free) space between the individual fingers of the spacer disk. The resulting wide channels of unoccupied free space run uninterrupted between the air holes and cathode assembly and improve the flow of air to the cathode assembly. The spacer disk simultaneously provides sufficient support to the cathode assembly preventing it from bending into the air inlet space (plenum region) of the cathode can.

The air spacer member may be in the form of a disk having a star-like configuration. The disk may be shaped so that there are pointed star-like sections jutting out from the center of the disk. Each section may be formed of a pair of straight or curved side walls which terminate in a pointed apex. There may be, for example, two, three, or more pronged sections. There can be wide unoccupied channels of space between adjacent pronged sections of the disk. The spacer disk is placed within the air inlet (plenum region) of the cathode can and registered so that the unoccupied channels of free space between the individual pronged sections of the disk are aligned to underlie individual air holes in the closed end of the cathode can. The resulting individual wide channels of unoccupied free space run in continuous paths, preferably perpendicular paths, between the air holes and cathode assembly and improve the flow of air to the cathode assembly. The spacer disk simultaneously provides sufficient support to the cathode assembly preventing it from bending into the air inlet space (plenum region) of the cathode can.

The air spacer member may in the form of a disk having one or more apertures running therethrough, for example, in the center of the disk. Each aperture running through the disk has a diameter or is wider than the air holes in the cathode can. Typically there is one aperture in the center of the disk. The diameter of the disk is smaller than the distance between pairs of opposing air holes in the cathode can. Thus, when the spacer disk is inserted into the air inlet space (plenum region) of the cathode can, there are wide channels of unoccupied free space underlying preferably each of the air holes in the cathode can including air holes that lie outside of the disk peripheral edge. Thus, some of the wide channels of unoccupied free space underlying the air holes in the cathode can are formed by free space residing outside of the spacer disk peripheral edge and other channels of unoccupied free space are formed by wide apertures running through the spacer disk. Such wide channels of unoccupied free space run uninterrupted and preferably perpendicularly between the air holes and cathode assembly and thus improve the flow of air to the cathode assembly. The spacer disk simultaneously provides sufficient support to the cathode assembly preventing it from bending into the air inlet space (plenum region) of the cathode can.

The air spacer member of the invention may be in the form of a mesh or grid of woven or non woven polymer or metal fiber. Preferably air spacer member is formed of a mesh of woven polymer fiber, for example, woven fibers of nylon, polyolefin, or polyester or other common durable polymer fiber. Alternatively, it may be formed of a mesh of woven metallic fiber, for example, woven stainless steel fiber. Preferably, the mesh is woven so that there are relatively wide openings creating channels of unoccupied free space between the fibers. The mesh may be woven so that there are formed unoccupied channels of “free space” which have diameter generally larger than the diameter of each of the air holes in the cathode can. The mesh is inserted into the air inlet space (plenum region) of the cathode can. The mesh thus abuts the air holes on one side and the cathode assembly on the opposite side. Preferably, the channels of “free space” underlying the air holes run perpendicularly between each respective air hole to the cathode assembly. However, the channels of “free space” formed by spaces between the fibers may take other pathways (non perpendicular) pathways between each air holes and cathode assembly. The individual channels of free space running through or around the mesh member of the invention which underlie the individual air holes in the cathode can are characterized in that they have a diameter at least 2 times and desirably between about 2 and 18 times, typically between about 2 and 16 times, for example, between about 3 and 16 times the diameter of the individual air holes in the cathode can. The total channels of free space running through or around the mesh member of the invention comprises between about 10 and 90 percent, typically between about 50 and 90 percent of the available space in the air inlet region (plenum region) located between the cathode can closed end and cathode assembly before the mesh member is inserted therein. The wide channels of unoccupied free space running through the mesh and underlying the individual air holes in the cathode can improve the distribution and flow of air to the cathode assembly. The mesh simultaneously provides sufficient support to the cathode assembly preventing it from bending into the air inlet space (plenum region) of the cathode can.

The air spacer member of the invention may be formed from a plurality of grooves or indentations, formed integrally on the outside surface of the closed end of the cathode casing or from projections from the inside surface of the cathode can reaching the cathode assembly. These features may be formed during or after fabrication of the cathode can, for example, by applying a punch or die to the top surface at the closed end of the cathode can. They may also be formed as the cathode can is stamped, such that the exterior surface at the closed end or terminal end of the cathode can remains flat. Projections can further be formed by depositing material in selected locations on the inside surface of the cathode can closed end. Such material could consist of nodules of epoxy, nylon, polyethylene or other plastic that is deposited from the melt or semi-liquid state, or prehardened materials that are fastened in place using adhesives. The grooves, indentations or projections are positioned in regions on the cathode can closed end preferably between rows of air holes penetrating the closed end. The placement of the grooves, indentations, or projections in this manner forms a plurality of channels of unoccupied (free) space underlying the air holes when the cathode assembly is inserted into the cathode can. The channels of unoccupied space created by the grooves, projections or indentations are of width which is desirably greater than the diameter of each of the air holes. The apex of each feature is positioned at level so that it may contact the flat surface of cathode assembly, thereby providing support to the cathode assembly. The channels of unoccupied (free) space resulting from such features in the cathode can which protrude into the air inlet space (plenum region) provide wide channels for air to pass from the air holes to the cathode assembly.

### BRIEF DESCRIPTION OF THE DRAWINGS

The invention will be better understood with reference to the drawings in which:

FIG. 1 is an isometric cross sectional view of an embodiment of the zinc/air cell of the invention.

FIG. 2 is an exploded view of a preferred embodiment of the catalytic cathode assembly shown in FIG. 1.

FIG. 3A is a pictorial view of the closed end of the cathode can shown in FIG. 1.

FIG. 3B is a pictorial view of a first embodiment of an air spacer member for placement within the air inlet space of the cathode can shown in FIG. 3A.

FIG. 3C is a cross sectional elevation view of the closed end of the cathode can of FIG. 3A with spacer member shown in FIG. 3B inserted within the air inlet space of the cathode can.

FIG. 4A is a pictorial view of the closed end of the cathode can shown in FIG. 1.

FIG. 4B is a pictorial view of a second embodiment of an air spacer for placement within the air inlet space of the cathode can shown in FIG. 4A.

FIG. 4C is a cross sectional elevation view of the closed end of the cathode can of FIG. 4A with the spacer member shown in FIG. 4B inserted within the air inlet space of the cathode can.

FIG. 5A is a pictorial view of the closed end of the cathode can shown in FIG. 1.

FIG. 5B is a pictorial view of a third embodiment of an air spacer member for placement within the air inlet space of the cathode can shown in FIG. 5A.

FIG. 5C is a cross sectional elevation view of the closed end of the cathode can of FIG. 5A with the spacer member shown in FIG. 5B inserted within the air inlet space of the cathode can.

FIG. 6A is a pictorial view of the closed end of the cathode can shown in FIG. 1.

FIG. 6B is a pictorial view of a fourth embodiment of an air spacer member for placement within the air inlet space of the cathode can shown in FIG. 6A.

FIG. 6C is a cross sectional elevation view of the closed end of the cathode can of FIG. 6A with the spacer member shown in FIG. 6B inserted within the air inlet space of the cathode can.

FIG. 7A is a pictorial view of the closed end of the cathode can shown in FIG. 1.

FIG. 7B is a pictorial view of a fifth embodiment of an air spacer member for placement within the air inlet space of the cathode can shown in FIG. 7A.

FIG. 7C is a cross sectional elevation view of the closed end of the cathode can of FIG. 7A with the spacer member shown in FIG. 7B inserted within the air inlet space of the cathode can.

FIG. 8A is a pictorial view of the closed end of the cathode can shown in FIG. 1 but with added grooves in the surface thereof.

FIG. 8B is a pictorial view of an embodiment of an air spacer member formed by grooves made on the closed end of the cathode can wherein the grooves function as spacer member for the air inlet space of the cathode can shown in FIG. 8A.

### DETAILED DESCRIPTION

The invention is directed to air depolarized electrochemical cells. Such cells have a metal anode, typically comprising zinc within an anode casing, and there is an air inlet to the cathode material within the cathode casing. The cell is commonly referred to as a metal/air or air-depolarized cell, and more typically a zinc/air cell.

The zinc/air cell of the invention is desirably in the form of a miniature button cell. It has particular application as a power source for small electronic devices such as hearing aids. But such cells may also be used to power other electronic devices. The miniature zinc/air button cell of the invention typically has a disk-like cylindrical shape of diameter between about 4 and 20 mm, for example, between about 4 and 16 mm, preferably between about 4 and 12 mm. The miniature zinc/air button cell has a height between about 2 and 9 mm, preferably between about 2 and 6 mm. The miniature zinc/air cell typically has an operating load voltage between about 1.2 Volts to 0.2 Volts. The cell typically has a substantially flat discharge voltage profile between about 1.1 and about 0.9 Volts whereupon the voltage can then fall fairly abruptly to zero. The miniature zinc/air cell can be discharged at a rate usually between about 0.2 and 25 milliAmperes. The term “miniature cells” or “miniature button cells” as used herein is intended to include such small size button cells, but is not intended to be restricted thereto, since other shapes and sizes for small zinc/air cells are possible. For example, zinc air cells could also be produced in somewhat larger sizes having a cylindrical casing of size comparable to conventional AAAA, AAA, AA, C and D size Zn/MnO₂ alkaline cells and even larger.

The cell of the invention may contain added mercury, for example, about 3 percent by weight of the zinc in the anode or can be essentially mercury free (zero added mercury cell). In such zero added mercury cells there is no added mercury and the only mercury present is in trace amounts naturally occurring with the zinc. Accordingly, the cell of the invention can have a total mercury content less than about 100 parts per million parts by weight of zinc, preferably less than 40 parts per million parts (ppm) by weight of zinc, more preferably less than about 20 parts per million parts by weight of zinc. (The term “essentially mercury free” as used herein shall mean the cell has a mercury content less than about 100 parts per million parts by weight of zinc.) The cell of the invention can have a very small amount of lead additive in the anode. If lead is added to the anode, the lead content in the cell can typically be between about 100 and 800 ppm of zinc in the anode. However, the cell desirably does not contain added amounts of lead and thus can be essentially lead free, that is, the total lead content is less than 30 ppm, desirably less than 15 ppm of zinc in the anode.

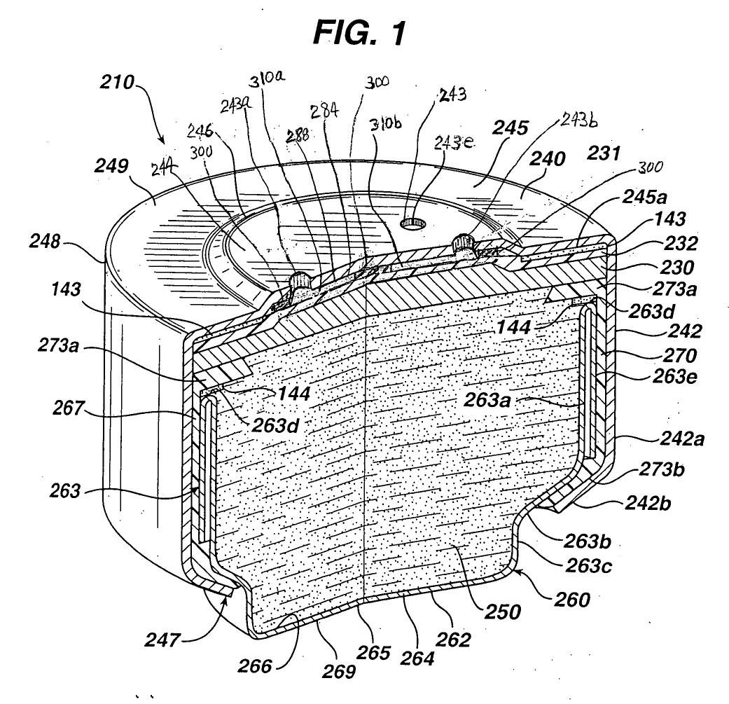

The zinc/air cell 210 of the invention (FIG. 1) has an anode casing 260, a cathode casing 240 and electrical insulator material 270 therebetween. The anode casing 260 and cathode casing 240 are preferably each in the form of a can or cup having a closed end and opposing open end. The anode casing 260 has body 263 forming the side walls, an integral closed end 269, and an open end 267. The cathode casing 240 has a body 242, an integral closed end 249 and an open end 247. The closed end 249 of the cathode casing (when the casing is held in vertical position with the closed end on top) typically has a raised portion 244 near its center. This raised portion 244 forms the positive terminal contact area and typically contains a plurality of air holes 243 therethrough. The cathode casing closed end 249 also typically has an annular recessed step 245 which extends from the peripheral edge 246 of the raised terminal portion to the outer peripheral edge 248.

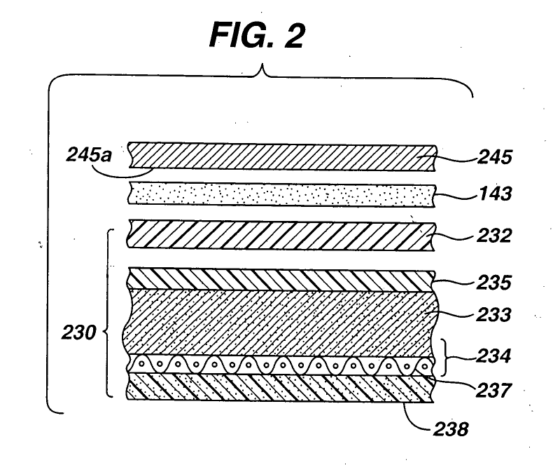

The anode casing 260 (anode can) contains an anode mixture 250 comprising particulate zinc and alkaline electrolyte. The particulate zinc is desirably alloyed with between about 100 and 1000 ppm indium. The zinc particles may also be plated with additional indium, preferably between about 100 and 1500 ppm indium. The cathode casing 240 has a plurality of air holes 243 in the raised portion 244 of its surface at the closed end thereof. A cathode catalytic assembly 230 containing a catalytic composite material 234 (FIG. 2) is placed within the casing proximate to the air holes. The catalytic composite 234 comprises a catalytic cathode mixture 233 in the form of a disk coated on a screen 237. During cell discharge, the catalytic material 233 facilitates the electrochemical reaction with ambient oxygen as it ingresses through air holes 243. An adhesive sealant 143 is applied along a portion of the inside surface of cathode casing 240. In a preferred embodiment the adhesive can be applied as a continuous ring on the inside surface 245a of recessed annular step 245 at the closed end 249 of the casing as shown in FIG. 1 and as also described in U.S. Pat. No. 6,436,156 B1. If the closed end of the cathode casing is flat, that is, does not have a recessed step 245, the adhesive sealant 143 can be applied to the inside surface of the closed end 249 adjacent the outer peripheral edge 248 of said closed end. In such latter case the adhesive sealant 143 is desirably applied as a continuous ring to the inside surface of closed end 249 such that the continuous ring of adhesive 143 has an outside diameter of between about 75 percent and 100 percent, preferably between about 90 and 100 percent, more preferably between about 95 and 100 percent of the inside diameter of closed end 249.

A representative cathode casing 240 (cathode can) is shown in FIG. 1. The cathode casing 240 is in the form of a can which has a closed end 249 and opposing open end 247 with body 242 (side walls) therebetween. The central portion 244 at the closed end 249 may be raised (as shown) and forms the positive terminal contact region. However, the entire closed end 249 may be flat, that is, without any raised central portion. There are one or more air holes 243 through the cathode casing closed end 249. There is an air inlet space 288 (plenum region) between the cathode casing closed end 249 and cathode assembly 230. Generally, the air inlet space 288 (plenum region) may be regarded as the available space between the inside surface of the cathode casing closed end 249 and cathode assembly 230 before any air diffuser material (e.g. spacer material 300 of the invention) is inserted therein. Conventionally, the air diffuser material is composed of air permeable paper or porous cellulosic material which is normally inserted to completely fill the available air inlet space 288.

In the embodiment shown in FIG. 1 there is a raised central portion 244 at the cathode casing closed end 249. In this embodiment (FIG. 1) the air inlet space 288 (plenum region) is the available space between the inside surface of the raised portion 244 of cathode casing closed end 249 and cathode assembly 230 before air diffuser material (or comparable) is inserted therein. For the purposes of this description any electrolyte barrier sheet, such as electrolyte barrier sheet 232 on the cathode assembly 230, may be considered as part of the cathode assembly 230. There are one or more air holes 243 through said raised portion 244. In the representative cathode casing 240 shown in FIG. 1 there are five air holes 243a-243e penetrating through the raised portion 244 of the cathode casing closed end 239.

A cathode catalytic assembly 230 (FIGS. 1 and 2) can be formed by laminating a layer of electrolyte barrier film material 235, preferably Teflon (polytetrafluoroethylene), to one side of the catalytic composite material 234 and an ion permeable separator material 238 to the opposite side. The electrolyte barrier film 235, preferably of Teflon, has the property that it is permeable to air, yet keeps water and electrolyte from passing therethrough. The edge of cathode catalytic assembly 230 can be applied to said adhesive ring 143 on step 245 thereby providing a permanent adhesive seal between the cathode assembly 230 and casing step 245. The cathode catalytic assembly 230 can be applied to adhesive 143 on step 245 with the electrolyte barrier 235 contacting adhesive 143 directly. (Optionally an additional electrolyte barrier sheet 232 (FIGS. 1 and 2) may be overlaid on electrolyte barrier 235 and bonded to adhesive 143 as described in the following paragraph.) The use of adhesive sealant 143 also reduces the amount of crimping force needed during crimping the outer peripheral edge 242b over the anode casing body. This is particularly advantageous with thin walled anode and cathode casings 240 and 260 of wall thickness between about 0.001 inches (0.0254 mm) and 0.015 inches (0.38 mm), particularly with anode and cathode casing wall thicknesses between about 0.002 and 0.005 inches (0.0508 and 0.127 mm). The use of adhesive sealant 143 is also advantageous when thin catalytic cathode assemblies 230 are employed since high crimping forces could possibly distort or crack such thin casings and cathode assemblies.

In a preferred embodiment a separate electrolyte barrier sheet 232, preferably of Teflon, can be applied to adhesive ring 143 on the inside surface 245a of step 245, thereby bonding electrolyte barrier sheet 232 to the inside surface of step 245. The catalytic assembly 230 can then be applied over electrolyte barrier sheet 232, preferably with the surface of second electrolyte barrier sheet 235, preferably of Teflon, contacting the barrier sheet 232 (FIG. 2). In this embodiment the additional electrolyte barrier sheet 232 may be considered as part of the cathode assembly 230. The barrier sheet 232 when bonded to the inside surface 245a of step 245, particularly in combination with a second barrier sheet 235 (FIG. 2) being applied against barrier sheet 232, provides a very effective seal preventing electrolyte from migrating through or around the edge of catalytic assembly 230 and gradually leaking out of air holes 243. Such effective seal eliminates the need to employ a conventional blotter type air diffuser, typically of paper or porous cellulosic material to fill air inlet space 288 plenum region) to absorb leaking electrolyte. That is, it has been determined as a part of the invention herein that the air spacer of the invention, for example spacer 300 replacing conventional blotter paper, does not need to have the property that it absorbs liquid electrolyte. This is because there is no leakage of electrolyte expected into the air inlet space 288 because of the tight seal employed around the cathode assembly 230 resulting in measure from the use of adhesive ring 143 and electrolyte barrier sheets 232 and 235.

Conventional blotter air diffuser material is of air permeable paper or porous cellulosic material which is inserted against the closed end 249 of the cathode casing 240 so that it covers air holes 243 and completely fills air inlet space 288. Although such air diffuser material acts as a cushion preventing the cathode assembly 230 from bending into the air inlet space 288, it can impede the free flow of incoming air to the cathode assembly 230.

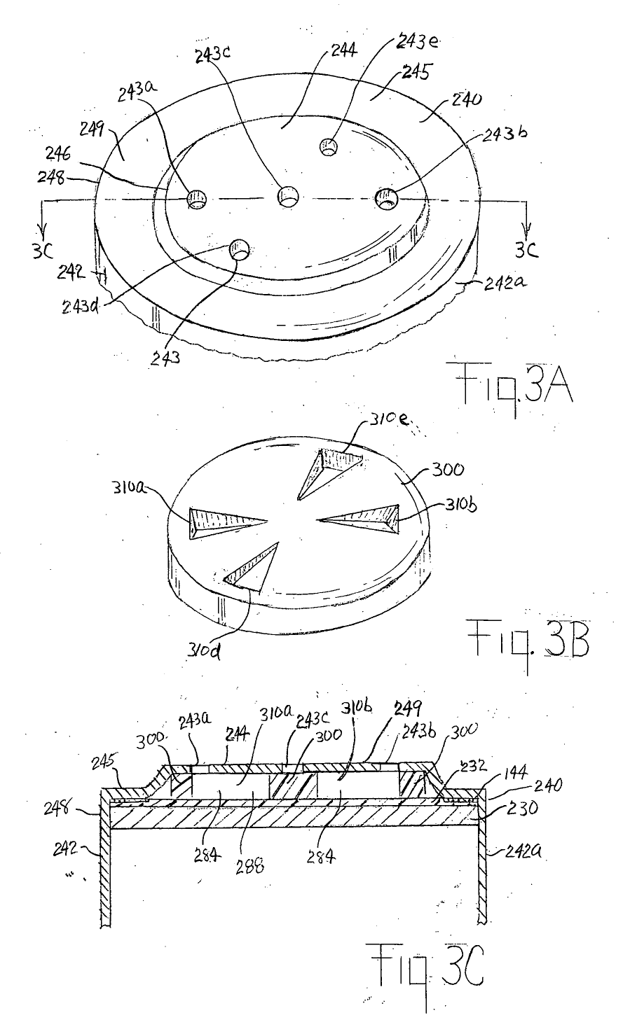

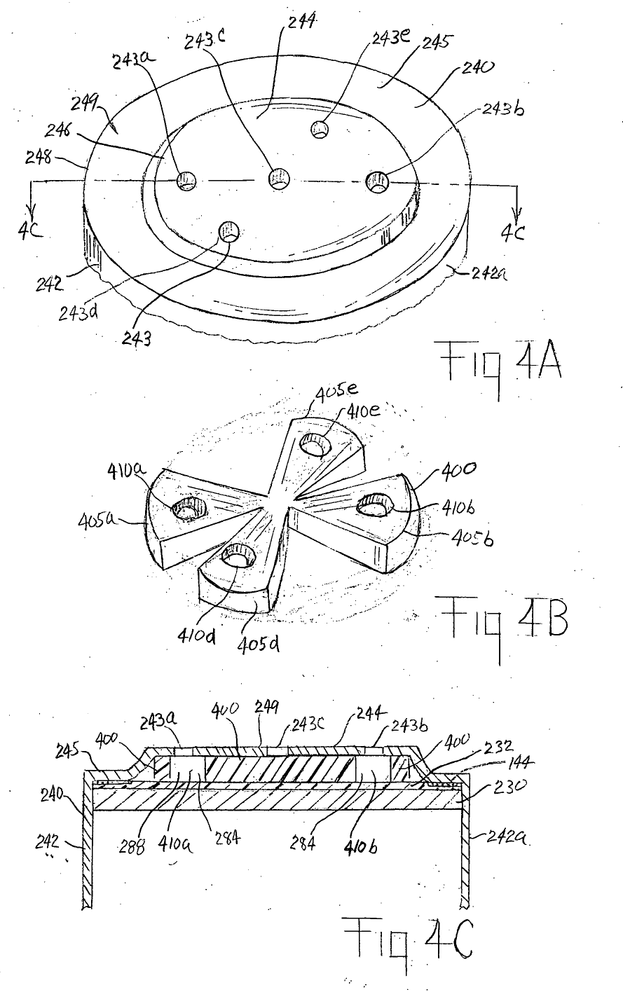

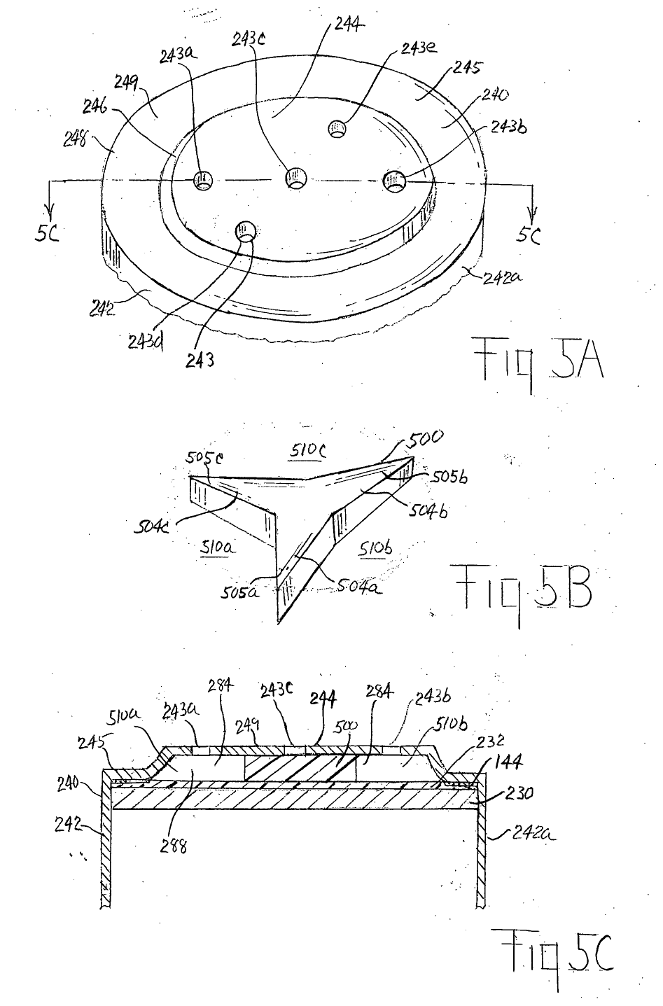

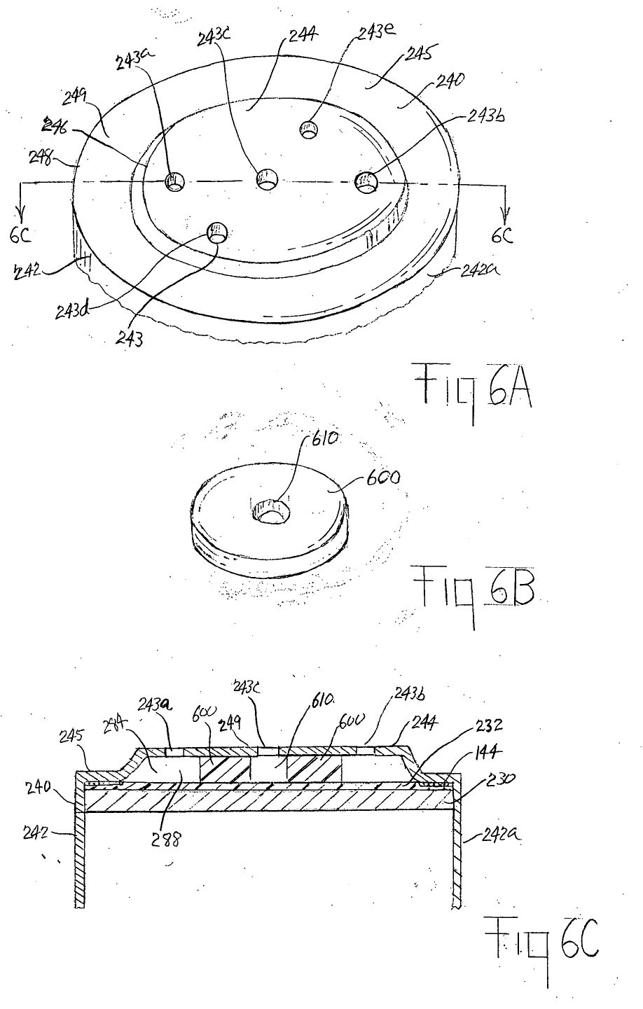

It has been determined in the present invention that conventional air diffuser material filling available air inlet space 288 can be replaced with solid plastic or metal structures of varying configurations. Such structures are herein referred to as air spacer members of the invention. Specific embodiments of such spacer members which are intended to be representative of the invention are presented herein as spacer members 300 (FIG. 3A); 400 (FIG. 4B); 500 (FIG. 5B); and 600 (FIG. 6B). These spacer members are preferably of durable plastic material. For example, they may be of same or similar material as insulator disk 270. As such they may typically be of nylon, polyethylene, polypropylene or generally any plastic material that is durable and resists compression. The material used for these spacer members does not need to be permeable to air. Alternatively, the above spacer members 300, 400, 500, and 600 may be of compression resistant rubber such as styrene-butadiene (SBR) rubber or silicone rubber. These spacer members may also be of oxidation resistant metal, preferably stainless steel.

The above air spacer members 300, 400, 500, and 600, which are representative of the invention, have apertures or cut out sections therethrough which form “channels of unoccupied (free) space” when they are inserted within the air inlet region 288 (plenum region) of the cathode can 240. The spacer members 300, 400, 500, and 600 may be of a disk-like shape. The peripheral edge of the spacer member may be circular, noncircular, irregular or jagged depending on the shape and placement of the apertures or cut out sections therethrough. The thickness of the spacer member, however, is preferably uniform and about equal to the depth of the air inlet region 288 within cathode can 240. When inserted and registered properly within air inlet region 288 said air spacer members of the invention form “channels of unoccupied free space” 284 underlying at least a majority of air holes 243, and such unoccupied channels 284 extend between at least the majority of the air holes 243 and the cathode assembly 230. The channels of unoccupied free space 284 run continuously between individual air holes 243 and the cathode assembly 230. The “unoccupied channels” are preferably channels of “free space” extending perpendicularly from an individual air hole 243 to the cathode assembly 230. The “channels of unoccupied space” underlying the air holes 243 have a diameter or are wide enough that they cover the cross section of individual air holes. Preferably the channels of unoccupied space have diameter which are greater than the diameter of the air holes. Desirably there are enough individual “unoccupied channels” underlying at least the majority of the air holes. Since such individual “unoccupied channels” are continuous, that is, with no obstructions between at least the majority of the individual air holes 243 and the cathode assembly 230, air will flow through the individual air holes 243 directly to the cathode assembly 230. This provides a more effective and more efficient air flow distribution within air inlet space 288 (plenum region) of cathode can 240 than if conventional air diffuser material (air permeable paper or porous cellulosic material) were used. The conventional air diffuser material would fill available air inlet space 288 and cover the air holes 243. By contrast the spacer members of the invention have pockets of “unoccupied space” forming individual continuous channels of free space 284 underlying the air holes 243.

The individual channels of free space 284 running through or around the spacer member, for example, spacer members 300, 400, 500, and 600 of the invention are characterized in that they have a diameter which is at least 2 times and desirably between about 2 and 18 times, typically between about 2 and 16 times, for example, between about 3 and 16 times the diameter of individual air holes in the cathode can which they underlie. (The term “diameter” as used herein shall be interpreted to include the equivalent diameter for non-circular holes or apertures. The equivalent diameter is the diameter which gives the same actual cross sectional area of the hole or aperture as if the cross sectional area is that of a circle. The cross sectional area of the hole or aperture is the area taken through a plane perpendicular to the longitudinal axis of the hole or aperture.) The total channels of free space 284 running through or around the air spacer member of the invention comprises between about 10 and 90 percent, typically between about 50 and 90 percent of the available space in the air inlet region 288 (plenum region) located between the cathode can closed end 249 and cathode assembly 230 before the spacer member of the invention is inserted therein.

Representative embodiments of the spacer members of the invention, for example, space members 300, 400, 500, and 600 are illustrated in the cross sectional drawings of FIGS. 3C, 4C, 5C, and 6C, respectively, which show placement of the spacer members within the air inlet space 288 of the cathode can. Importantly, the air spacer members of the invention, for example, spacer members 300, 400, 500, and 600, also provide sufficient support to the cathode assembly 230, preventing said cathode assembly 230 from bending or otherwise protruding into the air inlet space 288 (plenum region) during cell assembly or cell usage. Thus, the air spacer members of the invention such as spacer members 300, 400, 500, and 600 which are of solid plastic, rubber, or metal improves air flow to the cathode assembly 230 thereby improving cell performance and efficiency while simultaneously providing sufficient support for the cathode assembly 230 so that it cannot bend or protrude into the air inlet space 288.

In a first embodiment of the invention a spacer member 300 having the configuration shown best in FIG. 3B is inserted into the air inlet space 288 (plenum region) underlying air holes 243. Spacer member 300 (FIG. 3B) is inserted against the inside surface of cathode casing closed end 249 (FIG. 3A). Spacer member 300 is inserted within the available air inlet space 288 between closed end 249 of cathode casing 240 and cathode assembly 230 (FIG. 3C). A cross section of spacer member 300 inserted into the available inlet space 288 of the cathode casing 240 is shown in FIG. 3C. Spacer member 300 may of durable plastic material which resists compression, for example, nylon, high density polyethylene or polypropylene or other common plastics. Alternatively, spacer member 300 may of compression resistant rubber, such as styrene-butadiene rubber or silicone rubber or it may be of oxidation resistant metal, for example, stainless steel. Spacer member 300 might also be formed form traditional blotter paper or other air permeable materials. Spacer member 300 (FIG. 3B) is preferably in the form of a disk having a plurality of polyhedron or partial polyhedron sections therethrough. The walls of the cut out sections may thus have curvature or they may be straight or substantially straight. The cut out sections may be within the bounds of the circumferential peripheral edge of the disk as shown in FIG. 3B. In the embodiment shown in FIG. 3B spacer disk 300 has four cut out sections 310a, 310b, 310d, and 310e which have triangular side wall and thus appear to have a pyramidal or partial pyramidal shape, but may also be of prismatic shape. The closed end 249 of the cathode can 240 may have a typical five air hole 243a-243e arrangement as shown in FIG. 3A. The air hole arrangement shown in FIG. 3A is illustrative, since it will be appreciated that other arrangement of air holes may be employed. Also it will be appreciated that the number of air holes 243 may vary, and therefore is not intended to be restricted to five.

Spacer disk 300 is inserted into the available air inlet space 288 (plenum region) underlying air holes 243. The spacer disk 300 is preferably registered so that cut out sections 310a and 310b underlie air 243a and 243b, respectively. Cut out sections 310d and 310e underlie air holes 243d and 243e, respectively. Thus, there will be channels of unoccupied (open) space 284 for at least the regions within air inlet space 288 underlying air holes 243a, 243b, 243d, and 243e. Only air hole 243c (which may be eliminated) will have material from spacer disk 300 underlying and blocking this air hole. (Thus, in the configuration of spacer disk 300 shown in FIG. 3. four out of five of the air holes will have channels of unoccupied (free) space underlying these holes, when the air spacer disk 300 is inserted and registered within air inlet space 284.) The unoccupied space underlying each of these air holes is in the form of individual continuous channels which have a diameter at least as great as the diameter of each of the air holes. (Each channel of unoccupied space 284 runs continuously from an air hole 243 at the cathode can closed end 249 to the cathode assembly 230, which includes any electrolyte barrier sheet 232.) The air holes 243 each have a diameter between about 7 mil and 15 mil (0.178 mm and 0.381 mm), typically between about 7 and 12 mil (0.178 and 0.305 mm). When spacer disk 300 is inserted under the air holes 243, each individual channel of unoccupied (free) space 284 underlying air holes 243a, 243b, 243d, and 243e will have a diameter at least as great and preferably exceeding the diameter of each of these air holes as shown in FIG. 3C.

In the cross sectional drawing shown in FIG. 3C the channel of unoccupied (free) space 310a underlying air hole 243a is shown and the channel of unoccupied (free) space 310b underlying air hole 243b is shown. Solid material 300 is shown within air inlet space 284 between the unoccupied (free) space 310a and 310b as shown best in FIG. 3C. Similarly there is solid material 300 between unoccupied (free) space 310c and 310d underlying air holes 243d and 243e, respectively. Desirably the cut out sections 310a-310c in spacer disk 300 may be sized so that the amount of unoccupied (free) space 284 (defined by cut out sections 310a-310c) is between about 10 and 90 percent, typically between about 50 and 90 percent of the available space 288 (plenum region) before the spacer disk 300 is inserted therein. The solid material between the cut out sections 310a-310d of spacer disk 300 provides support for the underlying cathode assembly 230, and prevents the cathode assembly 230 from bending into the air inlet space 288 during cell assembly or usage. Simultaneously, the channels of unoccupied (free) space 284 underlying air holes 243a, 243b, 243d, and 243e provide unobstructed air distribution of air entering these air holes. Thus incoming air from these air holes passes directly to the cathode assembly 230. Such unobstructed distribution of incoming air improves overall cell performance compared to conventional embodiments wherein all of the available air inlet space 288 (plenum region) underlying the air holes 243 is completely filled with air diffuser material such as paper or porous cellulosic material.

A second embodiment of the air spacer of the invention is shown as air spacer member 400 (FIG. 4B). Air spacer 400 may be a disk shaped member having a plurality of fingers or leafs jutting out from the center of the disk. In the embodiment shown in FIG. 4B the spacer disk 400 has four fingers 405a, 405b, 405d, and 405e jutting out from the center of the disk. There is an aperture 410a, 410b, 410d, and 410e in each finger respectively. Spacer member 400 (FIG. 4B) is inserted against the inside surface of cathode casing closed end 249 (FIG. 4A). Spacer member 400 is inserted within the available air inlet space 288 between closed end 249 of cathode casing 240 and cathode assembly 230 (FIG. 4C). A cross section of spacer member 300 inserted into the available inlet space 288 (plenum region) of the cathode casing 240 is shown in FIG. 3C. The spacer 400 may of durable plastic, rubber, or metal such as stainless steel as described in the previous embodiment. It will be appreciated that the configuration of air spacer member 400 may have fewer or greater number of fingers depending on the number of air holes 243 in cathode can 240. With the number and alignment of air holes 243 shown in FIG. 4A by way of specific example, the configuration of air spacer member 400 may desirably be as shown in FIG. 4B.

Air spacer disk 400 is inserted within air inlet space between the cathode can closed end 249 and cathode assembly 230. Spacer disk 400 is registered so that aperture 410a underlies air hole 243a, aperture 410b underlies air hole 243b, aperture 410d underlies air hole 243d, and aperture 410e underlies air hole 243e. The apertures 410a, 410b, 410d, and 410e have a larger diameter than the diameter of the respective air holes 243a, 243b, 243d, and 243e. Channels of unoccupied (free) space are thus formed directly under the air holes 243a, 243b, 243d, and 243e so that air entering these air holes passes directly to cathode assembly 230. Only air hole 243c is blocked by underlying material from air spacer 400, and in the embodiment shown, hole 243c may be eliminated. Additionally, there are channels of unoccupied (free) space between fingers 405a, 405b, 405d, and 405e. Thus when air spacer 400 is inserted into the air inlet region 288 of cathode can 240 there are individual channels of unoccupied space 284 underlying each of the air holes 243a, 243b, 243d, and 243e and additional channels of free space created from the space between fingers 405a, 405b, 405d, and 405e. Desirably, the total unoccupied space created by air spacer 400 may be between about 10 and 90 percent, typically between about 50 and 90 percent of the total available space of the air inlet (plenum) region 288 of cathode casing 240 before air spacer 400 is inserted therein.

As in the previous embodiment the solid material in air spacer disk 400 provides support for the underlying cathode assembly 230, and prevents the cathode assembly 230 from bending into the air inlet space 288 during cell assembly or usage. Simultaneously, the channels of unoccupied (free) space 284 underlying air holes 243a, 243b, 243d, and 243e provides unobstructed air distribution from air entering these air holes to cathode assembly 230. Thus incoming air from these air holes passes directly to the cathode assembly 230. Such unobstructed distribution of incoming air improves overall cell performance compared to conventional embodiments wherein all of the available air inlet space 288 (plenum region) underlying the air holes 243 is completely filled with air diffuser material such as paper or porous cellulosic material.

A third embodiment of the air spacer member of the invention is shown as air spacer 500 (FIG. 5B). The air spacer 500 has a star-like configuration. In the configuration shown in FIG. 5B spacer member is in the shape of three prong star configuration having three integral sections 504a, 504b, and 504c. Each section may be formed of a pair of straight or curved side walls which terminate in a pointed apex 505a, 505b, and 505c, respectively as shown in FIG. 5B. There is a wide unoccupied space 510a between apex 505a and 505c; there is a wide unoccupied space 510b between apex 505a and 505b; and there is a wide unoccupied space 510c between apex 505b and 505c. Spacer member 500 (FIG. 5B) is inserted against the inside surface of cathode casing closed end 249 (FIG. 5A). Spacer member 500 is inserted within the available air inlet space 288 between closed end 249 of cathode casing 240 and cathode assembly 230 (FIG. 5C). As in the previous two embodiments air spacer 500 may be formed of compression resistant durable plastic material, for example, nylon, polyethylene, polypropylene or other common plastics. Alternatively, air spacer 500 may be of rubber or metal such as stainless steel. Air spacer member 500 is desirably inserted into the air inlet space 288 underlying air holes 243 and is registered so that unoccupied space 510a underlies air holes 243a and 243d; unoccupied space 510b underlies air hole 243b; and unoccupied space 510c underlies air hole 243e of the cathode can 240. Thus, the only air hole which has material underlying it is air hole 243c, which can be eliminated. Alternatively, there may be an aperture (not shown) running through the center of air spacer member 500 so that this central aperture underlies air hole 243c when air spacer 500 is inserted within air inlet space 284. When air spacer 500 is inserted and registered in the above described manner, there will be channels of unoccupied space underlying at least 4 out 5 of the air holes 243 in the cathode can.

In cross sectional FIG. 5C is shown channels of unoccupied space 284 underlying air holes 243a and 243b. Similarly, there will be channels of unoccupied space 284 underlying air holes 243d and 243e as above described. It will be observed that these channels of unoccupied space 284 are desirably wider than the diameter of the individual air holes, thus assuring that there is adequate unoccupied space 284 between the cathode casing end 249 and the cathode assembly 230. Desirably, the total unoccupied space 284 created by air spacer 500 may be between about 10 and 90 percent, typically between about 50 and 90 percent of the total available space of the air inlet (plenum) region 288 of the cathode casing 240 before air spacer 500 is inserted therein.

As in the previous embodiments the solid material in air spacer disk 400 provides support for the underlying cathode assembly 230, and prevents the cathode assembly 230 from bending into the air inlet space 288 during cell assembly or usage. Simultaneously, the unoccupied (free) space 284 underlying air holes 243a, 243b, 243d, and 243e provides unobstructed air distribution of air entering these air holes. Thus incoming air from these air holes passes directly to the cathode assembly 230. Such unobstructed distribution of incoming air improves overall cell performance compared to conventional embodiments wherein all of the available space in the air inlet space 288 (plenum region) underlying the air holes 243 is completely filled with air diffuser material such as paper or porous cellulosic material.

A fourth embodiment of the air spacer member of the invention is shown as air spacer 600 (FIG. 6B). In this embodiment the air spacer is in the form of a disk 600 having a central aperture 610 therethrough as shown in FIG. 6B. Spacer disk 600 (FIG. 6B) is inserted against the inside surface of cathode casing closed end 249 (FIG. 6A). Spacer disk 600 is inserted within the available air inlet space 288 between closed end 249 of cathode casing 240 and cathode assembly 230 (FIG. 6C). Air spacer disk 600 is inserted against the inside surface of closed end 249 of the cathode casing 240 so that the central aperture 610 underlies air hole 243c. The diameter of central aperture 610 is greater than the diameter of air hole 243c. Air spacer disk 600 has a diameter which is less than the distance between air holes 243a and 243b. The diameter of air spacer disk 600 has a diameter which is also less than the distance between air holes 243d and 243e. As may be seen from the cross sectional drawing of FIG. 6C each of the unoccupied channels of free space 284 underlying air holes 243a, 243b, and 243c have a diameter which is greater than the diameter of the respective air hole. Similarly, unoccupied channels of free space (not shown) of diameter greater than the air holes 243d and 243e are formed when air spacer disk 600 is inserted against the closed end 249 of cathode casing 240, since the diameter of disk 600 is less than the distance between air holes 243d and 243e. In sum there are unoccupied (free) channels of space 284 between each of the air holes 243a-243e and cathode assembly 230 wherein each of said unoccupied (free) channels 284 is greater than the diameter of each respective air holes. Desirably, the total unoccupied space created by air spacer 600 comprises between about 10 and 90 percent, typically between about 50 and 90 percent of the total available space of the air inlet (plenum) region 288 of the cathode casing 240 before air spacer 600 is inserted therein.

The solid material in air spacer disk 600 provides support for the underlying cathode assembly 230 and prevents the cathode assembly 230 from bending into the air inlet space 288 (plenum region) during cell assembly or usage. Simultaneously, the unoccupied (free) space 284 underlying air holes 243a, 243b, 243d, and 243e provides unobstructed air distribution of air entering these air holes. Thus incoming air from these air holes passes directly to the cathode assembly 230. Such unobstructed distribution of incoming air improves overall cell performance compared to conventional embodiments wherein all of the available air inlet space 288 (plenum region) underlying the air holes 243 is completely filled with air diffuser material such as paper or porous cellulosic material.

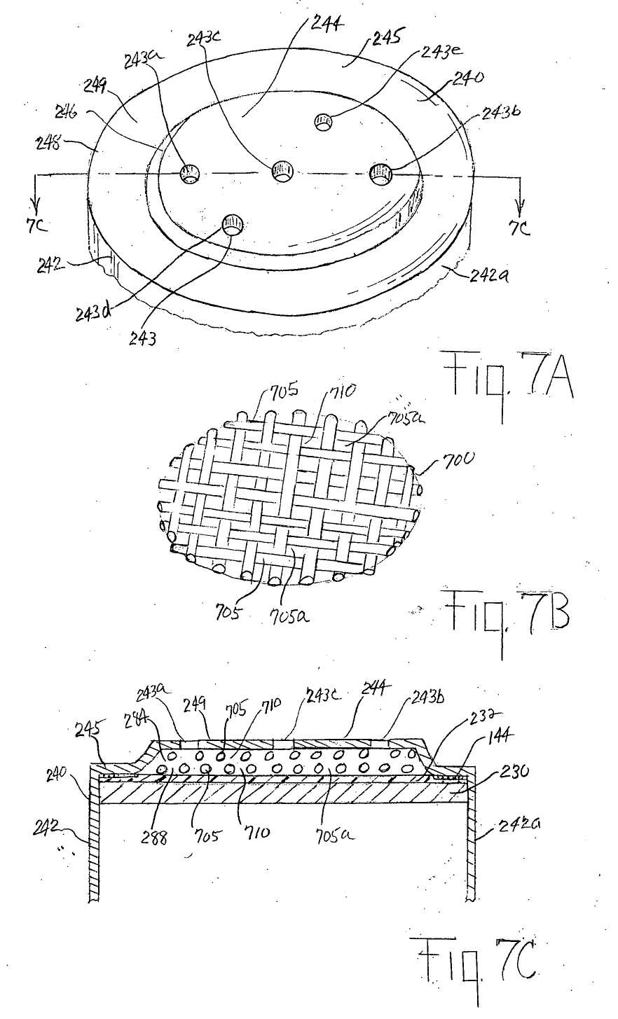

A fifth embodiment of the air spacer member of the invention is shown as air spacer 700 (FIG. 7B). In the embodiment shown in FIG. 7B the air spacer is formed of a mesh of woven or non-woven polymer or metal fiber. Preferably air spacer 700 is formed of a mesh of woven polymer fiber 705. The polymer fiber 705 may be chosen from a host of common durable plastic materials. A preferred polymer fiber is nylon, but may suitably be of polyester, or polyolefin fiber, for example, polyethylene or polypropylene fiber as well as other durable polymeric fibers, which may be readily woven into a mesh. Alternatively, air spacer 700 may be formed of a mesh of metal fiber 705, preferably woven stainless steel fiber. Preferably, the mesh 700 is woven so that the openings 705a between fibers 705 are sufficiently large that unoccupied channels of “free space” are formed between the fibers.

The mesh 700 may be woven so that there are formed unoccupied channels of “free space” 705a which have diameter generally larger than the diameter of each of the air holes 243a-243e. Preferably, the channels of “free space” 705a which underlie the air holes 243a-243e run perpendicularly and continuously between each respective air hole to the cathode assembly 230. However, the channels of “free space” formed by spaces 705a between the fibers may take other pathways (non perpendicular) pathways between each air holes 243a-243e and cathode assembly 230. The diameter or width of at least the majority of such channels of “free” space have diameter or width which is greater than the diameter of the individual air holes 243a-243e. Such large channels of free space 705a assure that there will be high rate of air diffusion from the air holes 243a-243e to the cathode assembly 230. The diameter of at least the majority of such channels of “free” space running through the mesh are at least 2 times and desirably between about 2 and 18 times, typically between about 2 and 16 times the diameter of the individual air holes. Desirably, the channels of free space 705a within spacer mesh 700 comprises between about 10 and 90 percent, typically between about 50 and 90 percent of the total available space within the air inlet (plenum) region 288. The mesh 700 simultaneously provides sufficient support to the cathode assembly 230 to prevent the cathode assembly 230 from bending into the air inlet region 288 between the cathode casing closed end 249 and cathode assembly 230.

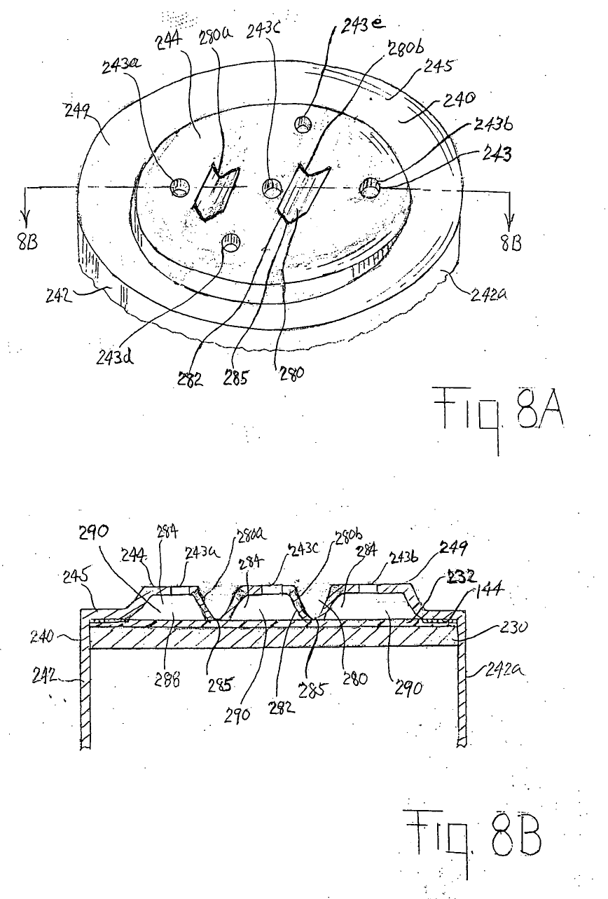

A sixth embodiment of the air spacer member of the invention is shown in FIGS. 8A and 8B. In this embodiment at least one groove and typically plurality of grooves or indentations 280, for example, grooves 280a and 280b are formed on the surface of raised portion 244 of the cathode casing closed end 249. Such grooves or indentations 280 form features such as apex 285 which project into the air inlet space (plenum region) 284. If only one groove or indentation 280 is employed then it is best placed in the center of raised surface 244. In such case the central air hole 243c may be eliminated. The grooves or indentations 280 may be formed during or after fabrication of the cathode casing 240, for example, by applying a punch or die to the top surface of raised portion 244. Alternatively, the projections 285 can be formed by stamping the inside surface of the cathode casing closed end 249 so that the outside surface of raised portion 244 of the closed end 249 is flat or substantially flat. Alternatively, the projections 285 may be formed by depositing globs of material in selected locations on the inside surface of raised portion 244 at the cathode casing closed end 249. Such material may consist of nodules of epoxy, nylon, polyethylene or other plastic that is deposited from a melt or semi-liquid state, or prehardened materials that are applied to the inside surface of raised portion 244 of cathode casing closed end 249, and may be fastened in place using adhesives. In such case the outside surface of raised portion 244 of the closed end 249 of the cathode casing would remain flat, that is, there would not be any indentations or grooves appearing on the outside surface, but projections 285, for example, in the representative positions shown in FIG. 8B or in other desired positions, would appear on the inside surface of closed end 249.

A typical groove 280 having side walls 282 terminating in apex 285 is formed as shown in FIG. 8A. The grooves 280a and 280b are positioned in regions on the cathode casing closed end 249 between the air holes 243 as shown in FIG. 8A. (Additional grooves may be supplied as desired.) Each groove 280a and 280b has a length which is desirably at least about three times the air hole 243 diameter and may have a maximum length up to about ⅓ the diameter of the available air inlet space 288 (approximately up to about ⅓ the diameter of raised surface 244). This allows incoming air to circulate freely around the groove side walls 282. The apex 285 of each of the grooves 280a and 280b is punched to at level that allows contact with the flat surface of cathode assembly 230 as shown in FIG. 8B. This provides sufficient support to the cathode assembly 230 and prevents it from bending during cell fabrication or cell usage. Each groove 280a and 280b has a width (as measured at its open end) which is at least about three times the diameter of air hole 243. The placement of the projections 285 formed from grooves or indentations 280a and 280b or alternatively formed from nodules of material applied to the inside surface of the cathode casing closed end 244 form a plurality of channels of unoccupied (free) space 290 underlying the air holes 243a-243e as shown best in FIG. 8B. The channels of unoccupied space 290 created by the grooves or indentations 280 or alternatively from nodules of material applied to the inside surface of the cathode casing closed end 244, are of width which is desirably greater than the diameter of each of the air holes. Desirably, the total unoccupied space created by channels 290 comprises between about 10 and 90 percent, typically between about 50 and 90 percent of the total available space of the air inlet (plenum) region 288 underlying raised surface 244 before the grooves or projections are formed. The channels of unoccupied (free) space 290 underlying air holes 243a, 243b, 243d, and 243e provide wide channels for air to pass from the air holes to the cathode assembly 230.

Thus incoming air from these air holes passes directly to cathode assembly 230 (FIG. 8B). Such unobstructed distribution of incoming air improves overall cell performance compared to conventional embodiments wherein all of the available air inlet space 288 (plenum region) underlying the air holes 243 is completely filled with air diffuser material such as paper or porous cellulosic material.

It will be appreciated that grooves or indentations 280 may be of configuration other than as shown in FIGS. 8A and 8B. For example, the indentation 280 may be of a conical or truncated conical (frustum) configuration. Other shapes of course are also possible. In such cases, however, the indentation 280 will have an apex 285 which contacts cathode assembly 230 as shown in FIG. 8B in order to provide sufficient support to cathode assembly 230 to prevent it from bending into air inlet space 288. Similarly, if the projections 285 are formed from nodules of material adhered to the inside surface of the casing closed end 249, then such nodules may also be of a variety of shapes, for example, they may have a disk-like shape, or may be conical or truncated conical (frustum) or polyhedron shape or other configurations of sufficient height to reach from the inside surface of the cathode casing closed end 249 to the cathode assembly 230.

A preferred embodiment of a complete zinc/air cell of the invention is shown in FIG. 1. The embodiment shown in FIG. 1 is in the form of a miniature button cell. The cell 210 comprises a cathode casing 240 (cathode can) an anode casing 260 (anode can) with an electrical insulator material 270 therebetween. The insulator 270 can desirably be in the form of a ring which can be inserted over the outside surface of the anode casing body 263 as shown in FIG. 1. A conventional water resistant sealing paste such as an asphalt or bitumen based sealant or polymeric sealant can be applied between the insulator 270 side wall and the anode casing outer wall 263e. The sealant (not shown) may be applied to the inside surface of insulator 270 wall before the insulator ring 270 is inserted over the anode can wall 263e. Insulator ring 270 desirably has an enlarged portion 273a extending beyond peripheral edge 263d of anode casing 240 (FIG. 1) forming an “L” shape configuration in cross section. The insulator 270 with enlarged portion 273a prevents anode active material from contacting the cathode casing 240 after the cell is sealed. Insulator 270 is of a durable electrically insulating material such as high density polyethylene, polypropylene or nylon which resists cold flow when squeezed.

The anode casing 260 and cathode casing 240 are initially separate pieces. The anode casing 260 and cathode casing 240 are separately filled with active materials, whereupon the open end 267 of the anode casing 260 can be inserted into the open end 247 of cathode casing 240. The anode casing 260 can have a folded side wall formed of a first outer straight body portion 263e which extends vertically upwards (FIG. 1) forming the casing 260 outer side walls. The straight body portion 263e may desirably be folded over once at edge 263d to form a first downwardly extending inner portion 263a of the anode casing side wall. The folded portions 263a and 263e thus form a double-sided wall which together provide spring-like tension and additional support between the anode casing body 263 and abutting seal wall 270. This helps to maintain a tight seal between the anode and cathode casings. Alternatively, the side walls of the anode casing 240 can be formed as a single wall 263a without folded portion 263e. However, the anode casing 240 with the folded (double) side wall, as shown in the figures herein, has been determined to be desirable for very thin walled casing, for example, having a wall thicknesses between about 2 and 5 mil (0.0508 and 0.127 mm, which thickness ranges apply to each fold 263a and 263e. These thickness ranges also apply to the closed end 269 of the anode can. In the anode casing having a folded side wall (FIG. 1), the inner side wall portion 263a terminates in an inwardly slanted portion 263b which terminates in a second downwardly extending vertical portion 263c. The second straight portion 263c is of smaller diameter than straight portion 263a. The portion 263c terminates with a 90° bend forming the closed end 269 having a preferably flat negative terminal surface 265.

The body 242 of cathode casing 240 has a straight portion 242a of maximum diameter extending vertically downwardly from closed end 249. The body 242 terminates in peripheral edge 242b. The peripheral edge 242b of cathode casing 240 and underlying peripheral edge 273b of insulator ring 270 are initially vertically straight as shown in FIGS. 3 and 4 and can be mechanically crimped over the slanted midportion 263b of the anode casing 260 as shown in FIG. 5. Such crimping locks the cathode casing 240 in place over the anode casing 260 and forms a tightly sealed cell.

Anode casing 260 can be separately filled with anode active material by first preparing a mixture of particulate zinc and powdered gellant material. The zinc average particle size is desirably between about 30 and 350 micron. The zinc can be pure zinc but is preferably in the form of particulate zinc alloyed with indium (100 to 1000 ppm). The zinc can also be in the form of particulate zinc alloyed with indium (100 to 1000 ppm) and lead (100 to 1000 ppm). Other alloys of zinc, for example, particulate zinc alloyed with indium (100 to 1000 ppm) and bismuth (100 to 1000 ppm) can also be used. These particulate zinc alloys are essentially comprised of pure zinc and have the electrochemical capacity essentially of pure zinc. Thus, the term “zinc” shall be understood to include such materials.

The gellant material can be selected from a variety of known gellants which are substantially insoluble in alkaline electrolyte. Such gellants can, for example, be cross linked carboxymethyl cellulose (CMC); starch graft copolymers, for example in the form of hydrolyzed polyacrylonitrile grafted unto a starch backbone available under the designation Waterlock A221 (Grain Processing Corp.); cross linked polyacrylic acid polymer available under the trade designation Carbopol C940 (B.F. Goodrich); alkali saponified polyacrylonitrile available under the designation Waterlock A 400 (Grain Processing Corp.); and sodium salts of polyacrylic acids termed sodium polyacrylate superabsorbent polymer available under the designation Waterlock J-500 or J-550. A dry mixture of the particulate zinc and gellant powder can be formed with the gellant forming typically between about 0.1 and 1 percent by weight of the dry mixture. A solution of aqueous KOH electrolyte solution comprising between about 30 and 40 wt % KOH and about 2 wt % ZnO is added to the dry mixture and the formed wet anode mixture 250 can be inserted into the anode casing 260. Alternatively, the dry powder mix of particulate zinc and gellant can be first placed into the anode casing 260 and the electrolyte solution added to form the wet anode mixture 250.

A catalytic cathode assembly 230 (FIGS. 1 and 2) and the air spacer of the invention can be inserted into cathode casing 240 as follows: An air spacer member 300 (FIG. 3B) is shown inserted into the air inlet space 288 of the cathode can 240 as shown in FIG. 1. It will be appreciated that any of the other embodiments of the air spacer of the invention described herein, for example, air spacer disk 400, 500, or 600 or spacer mesh 700 of the invention can be inserted into the cathode casing 240 instead of spacer disk 300 so that it lies within the air inlet space 288 of the cathode can as shown in FIG. 1. In the cathode casing embodiment shown in FIG. 1 the available air inlet space 288 (plenum region) is the region abutting the inside surface of the raised portion 244 at the closed end 249 of cathode casing 240. An adhesive sealant ring 143 is desirably applied to the inside surface 245a of recessed step 245 at the closed end of the cathode casing. A separate electrolyte barrier layer 232 (FIGS. 1 and 2), for example, of polytetrafluroethylene (Teflon) which becomes a part of the cathode assembly 230 can optionally be inserted on the underside of the air spacer disk 300 so that the edge of the barrier layer 232 contacts adhesive ring 143. Barrier layer 232 is permeable to air but not permeable to the alkaline electrolyte or water. The adhesive ring 143 thus permanently bonds the edge of barrier layer 232 to the inside surface of recessed step 245. The adhesive ring 143 with barrier layer 232 bonded thereto prevents electrolyte from migrating from the anode to and around cathode catalytic assembly 230 and then leaking from the cell through air holes 243. A catalytic cathode assembly 230 as shown in FIG. 2 can be prepared as a laminate comprising a layer of electrolyte barrier material 235, a cathode composite disk 234 under the barrier layer 235 and a layer of ion permeable separator material 238 under the catalyst composite 234, as shown in FIG. 2. The separator 238 can be selected from conventional ion permeable separator materials including cellophane, polyvinylchloride, acrylonitrile, and microporous polypropylene. Each of these layers can be separately prepared and laminated together by application of heat and pressure to form the catalytic assembly 230. The electrolyte barrier layers 232 and 235 can desirably be of polytetrafluroethylene (Teflon).

Catalytic cathode composite 234 desirably comprises a catalytic cathode mixture 233 of particulate manganese dioxide, carbon, and hydrophobic binder which is applied by conventional coating methods to a surface of an electrically conductive screen 237. Screen 237 may be of woven metallic fibers, for example, nickel or nickel plated steel fibers. The cathode mixture 233 is formed in the shape of a disk, which may be termed herein as the cathode disk. Other catalytic materials may be included or employed such as metals like silver, platinum, palladium, and ruthenium or other oxides of metals or manganese (MnOₓ) and other components known to catalyze the oxygen reduction reaction. During application the catalytic mixture 233 is substantially absorbed into the porous mesh of screen 237. The manganese dioxide used in the catalytic mixture 233 can be conventional battery grade manganese dioxide, for example, electrolytic manganese dioxide (EMD). The manganese dioxide in catalytic mixture 233 can also be manganese dioxide formed from the thermal decomposition of manganous nitrate Mn(NO₃)₂ or potassium permanganate KMnO₄. The carbon used in preparation of mixture 233 can be in various forms including graphite, carbon black and acetylene black. A preferred carbon is carbon black because of its high surface area. A suitable hydrophobic binder can be polytetrafluroethylene (Teflon). The catalytic mixture 233 may typically comprise between about 3 and 10 percent by weight MnO₂, 10 and 20 percent by weight carbon, and remainder binder. During cell discharge the catalytic mixture 233 acts primarily as a catalyst to facilitate the electrochemical reaction involving the incoming air. However, additional manganese dioxide can be added to the catalyst and the cell can be converted to an air assisted zinc/air or air assisted alkaline cell. In such cell, which can be in the form of a button cell, at least a portion of manganese dioxide becomes discharged, that is, some manganese is reduced during electrochemical discharge along with incoming oxygen. The adhesive ring 143 is intended to be applicable for use as well in such air assisted cells to prevent leakage of electrolyte therefrom.

In the preferred embodiment (FIG. 1) the anode casing 260 has a layer of copper 266 plated or clad on its inside surface so that in the assembled cell the zinc anode mix 250 contacts the copper layer. The copper plate is desired because it provides a highly conductive pathway for electrons passing from the anode 250 to the negative terminal 265 as the zinc is discharged. The anode casing 260 is desirably formed of stainless steel which is plated on the inside surface with a layer of copper. Preferably, anode casing 260 is formed of a triclad material composed of stainless steel 264 with a copper layer 266 on its inside surface and a nickel layer 262 on its outside surface as shown in FIG. 1. Thus, in the final assembled cell 210 (FIG. 1) the copper layer 266 forms the anode casing inside surface in contact with the zinc anode mix 250 and the nickel layer 262 forms the anode casing's outside surface. The copper layer 266 desirably has a thickness between about 0.0002 inches (0.005 mm) and 0.002 inches (0.05 mm). The nickel layer is between about 0.0001 inches (0.00254 mm) and 0.001 inches (0.0254 mm).

By way of a specific non-limiting example, the cell size could be a standard size 312 zinc/air cell having an outside diameter of between about 0.3025 and 0.3045 inches (7.68 and 7.73 mm) and a height of between about 0.1300 and 0.1384 inches (3.30 and 3.52 mm). The anode 250 can contain zero added mercury (mercury content can be less than 20 ppm of cell weight) and can have the following composition: zinc 78.1 wt % (the zinc can be alloyed with 200 to 800 ppm each of indium and lead), electrolyte (40 wt % KOH and 2 wt % ZnO) 21.9 wt %, gelling agent (Waterlock J-550) 0.3 wt %. Sufficient anode material 250 is supplied to fill the internal volume of anode casing 260. The cathode catalyst composite 237 can have the following composition: MnO₂ 4.6 wt. %, carbon black 15.3 wt %, Teflon binder 18.8 wt. %, and nickel mesh screen, 61.2 wt. %. The total cathode catalyst composite 237 can be 0.140 g.

The adhesive sealant 143 can be applied as a continuous ring to the inside surface of the cathode casing recessed step 245. The adhesive 143 to be applied to the inside surface 245a of step 245 may be a solvent based mixture comprising a polyamide based adhesive component as described in U.S. Pat. No. 6,436,156 B1 and incorporated herein by reference. The adhesive component is thus desirably a low molecular weight thermoplastic polyamide resin. A preferred polyamide resin is available under the trade designation REAMID-100 or VERSAMID-100 (from Henkel Corp. or Cognis Corp.). REAMID-100 or Versamid-100 is a low molecular weight polyamide which is a gel at room temperature. It is as a dimerized fatty acid which is the reaction product of a dimerized fatty acid and diamine. The adhesive mixture may be formed by dissolving the REAMID-100 polyamide in a solvent of isopropanol 50 parts by weight and toluene 50 parts by weight. The polyamide adhesive layer 143 applied to the inside surface 245a of cathode casing step 245 provides a very strong bond between Teflon sheet 232 and the nickel plated cathode casing step 245. The adhesive 143 also has the advantage that it is resistant to chemical attack from the potassium hydroxide electrolyte.

Cell 210 can be assembled by first inserting the cathode components above described into the precrimped cathode casing 240. The air spacer 300, 400, 500, 600, or 700 of the invention is inserted against air holes 42 within air inlet space 284. Alternatively, the air spacer 280 may be formed of a plurality of integral grooves 285 on closed end 249 of cathode casing 240. An electrolyte barrier layer 232, preferably of Teflon, is placed over the air spacer 300, 400, 500, 600, 700, or 280 of the invention. Preferably the inside surface 245a of the cathode casing step 245 is coated with the above described adhesive 143 so that the edge of electrolyte barrier layer 232 adheres to the inside surface 245a of step 245. Preferably, the bottom surface (facing the cell interior) of the enlarged portion 273a of the insulating sealing disk 270 is also coated with a ring of an adhesive 144 as shown in FIG. 1. Adhesive 144 may have the same composition as adhesive 143. Although the adhesive layers 143 and 144 can be omitted, it is desirably included, particularly for cells having anode and cathode casing wall thickness which are very thin. For example adhesive layers 143 and 144 is desirably included for cells 210 having anode and cathode casing wall thicknesses between about 2.0 and 5 mils (0.0508 and 0.127 mm).

The anode casing 260 may be drawn to the shape shown in FIG. 1, for example, having straight side walls formed of an inner portion 263a which is folded over once to form outer portion 263e. Thus, in effect a double side wall is formed of inner wall 263a and outer wall 263e. It will be appreciated that the anode casing 260 may be formed of a single (unfolded) side wall instead of the double side wall 263a and 263e shown. The double side wall is preferred if the anode casing 260 has very thin side walls, for example, between about 2 and 5 mil 0.0508 and 0.127 mm). An insulator seal ring 270 is applied over the anode casing side walls. The anode casing 260 is then filled with anode material 250 above described.

The cathode casing body 242 is then pushed over the outside surface insulator 270. Crimping forces are applied to crimp edge 242b of cathode casing 240 over slanted surface 263b of the anode casing 260 with insulator edge 273b therebetween. Radial forces may be applied during crimping to assure a tight seal between the anode and cathode casings.

Although the invention has been described with reference to specific embodiments, it should be appreciated that other embodiments are possible without departing from the concept of the invention. Thus, the invention is not intended to be limited to the specific embodiments but rather its scope is reflected by the claims and equivalents thereof.

What is claimed is:

1. A metal/air depolarized cell comprising an anode can and a cathode can, an anode material comprising zinc and alkaline electrolyte within said anode can, and a cathode assembly comprising cathode material within said cathode can; wherein the cathode can comprises an open end and opposing closed end and integral side wall therebetween; said cathode can closed end having an inside surface facing the cell interior and outside surface facing the external environment; wherein said anode can comprises an open end and opposing closed end and integral side wall therebetween; wherein the open end of the anode can resides within the open end of the cathode can with at least a portion of the cathode can side wall overlapping at least a portion of the anode can side wall with electrically insulating material between said overlapping wall portions; wherein there is at least one air hole running through the closed end of said cathode can, and the cathode assembly resides within the cathode can in proximity to the closed end of the cathode can adjacent an air hole; wherein there is an air inlet region between the inside surface of said closed end of the cathode can and the cathode assembly; wherein there is a spacer member inserted within said air inlet region; wherein said spacer member comprises material having at least one aperture therethrough and said aperture through said spacer member underlies at least one of said air holes in the cathode can closed end when the cell is viewed in vertical position with the cathode can on top.

2. The cell of claim 1 wherein there are a plurality of air holes in said cathode can closed end and there are a plurality of apertures through the spacer member; wherein said plurality of apertures underlie a plurality of air holes in the cathode can; and wherein said apertures through said spacer member have a diameter greater than the diameter of the air holes which they underlie.

3. The cell of claim 2 wherein the apertures in said spacer member underlying said air holes in the cathode can form continuous channels of unoccupied space between said plurality of the air holes and the cathode assembly.

4. The cell of claim 1 wherein said cathode assembly has a substantially flat surface facing said closed end of the cathode can.

5. The cell of claim 4 wherein said spacer member prevents said cathode assembly from bending into said air inlet region.

6. The cell of claim 2 wherein the apertures in said spacer member underlying said air holes in the cathode can form continuous channels of unoccupied space between the air holes and the cathode assembly, wherein said channels of unoccupied space have a diameter which is at least 2 times the diameter of the individual air holes which they underlie.

7. The cell of claim 6 wherein said channels of unoccupied space comprises between about 10 and 90 percent of the available space within said air inlet region of the cathode can, said available space is as measured before said spacer member is inserted therein.

8. The cell of claim 6 wherein said channels of unoccupied space comprises between about 50 and 90 percent of the available space within said air inlet region of the cathode can, said available space is as measured before said spacer member is inserted therein.

9. A metal/air depolarized cell comprising an anode can and a cathode can, an anode material comprising zinc particles and alkaline electrolyte within said anode can, and a cathode assembly comprising cathode material within said cathode can; wherein the cathode can comprises an open end and opposing closed end and integral side wall therebetween; said cathode can closed end having an inside surface facing the cell interior and outside surface facing the external environment; wherein said anode can comprises an open end and opposing closed end and integral side wall therebetween; wherein the open end of the anode can resides within the open end of the cathode can with at least a portion of the cathode can side wall overlapping at least a portion of the anode can side wall with electrically insulating material between said overlapping wall portions; wherein there is a plurality of air holes running through the closed end of said cathode can, and the cathode assembly resides within the cathode can in proximity to the closed end of the cathode can adjacent said air holes; wherein there is an air inlet region between the inside surface of said closed end of the cathode can and the cathode assembly; wherein there is a spacer member inserted within said air inlet region; wherein said spacer member comprises material having at least one aperture therethrough and said aperture through said spacer member underlies at least one of said air holes in the cathode can closed end when the cell is viewed in vertical position with the cathode can on top.

10. The cell of claim 9 wherein there are a plurality of apertures through the spacer member, and said plurality of apertures underlie a plurality of air holes in the cathode can, wherein said apertures through said spacer member have a diameter greater than the diameter of the air holes which they underlie.

11. The cell of claim 10 wherein the apertures in said spacer member underlying said air holes in the cathode can form continuous channels of unoccupied space between said plurality of air holes and the cathode assembly.

12. The cell of claim 9 wherein the number of apertures through said spacer member are greater in number than the number of air holes through said cathode can closed end.

13. The cell of claim 9 wherein said cathode assembly has a substantially flat surface facing said closed end of the cathode can.

14. The cell of claim 13 wherein said spacer member prevents said cathode assembly from bending into said air inlet region.

15. The cell of claim 10 wherein the apertures in said spacer member underlying said air holes in the cathode can form continuous channels of unoccupied space running through said spacer member between the air holes and the cathode assembly, wherein said channels of unoccupied space runs perpendicularly between said plurality of air holes and the cathode assembly.

16. The cell of claim 15 wherein said cathode assembly comprises cathode material and at least one electrolyte barrier sheet thereon.

17. The cell of claim 15 wherein said channels of unoccupied space have a diameter which is at least 2 times the diameter of the individual air holes which they underlie.

18. The cell of claim 17 wherein said channels of unoccupied space running through said spacer member comprises between about 10 and 90 percent of the available space within said air inlet region of the cathode can, said available space is as measured before said spacer member is inserted therein.

19. The cell of claim 17 wherein said channels of unoccupied space running through said spacer member comprises between about 50 and 90 percent of the available space within said air inlet region of the cathode can, said available space is as measured before said spacer member is inserted therein.

20. The cell of claim 15 wherein there is created at least one channel of unoccupied space located outside the peripheral edge of said spacer member wherein said channel of unoccupied space underlies at least one of said air holes.

21. The cell of claim 20 wherein said channels of unoccupied space located outside of the peripheral edge of said spacer member has a diameter which is at least 2 times the diameter of the individual air hole which it underlies.

22. The cell of claim 9 wherein said air holes have a diameter between about 7 mil and 35 mil (0.178 mm and 0.889 mm).

23. The cell of claim 9 wherein said cell has disk-like cylindrical shape having diameter between about 4 and 20 mm and a height between about 2 and 9 mm.

24. The cell of claim 23 wherein the anode can and cathode can wall thicknesses are thin between about 2.0 and 5 mils (0.0508 and 0.127 mm).

25. The cell of claim 9 wherein the anode comprises less than about 100 parts mercury per million parts of zinc by weight.

26. The cell of claim 9 where said spacer member is of disk-like configuration having uniform thickness.

27. The cell of claim 9 wherein said spacer member comprises solid plastic or metal material.

28. The cell of claim 9 wherein said spacer member comprises rubber material which resists compression.

29. The cell of claim 9 wherein said spacer member comprises a mesh of woven or unwoven fibers.

30. The cell of claim 29 wherein said mesh comprises a plurality of apertures between said fibers, wherein at least one of said apertures underlies an air hole.

31. The cell of claim 10 wherein said spacer member comprises a mesh of fibers and said mesh comprises a plurality of apertures between said fibers, wherein at least a plurality of said apertures underlie a plurality of said air holes.

32. The cell of claim 9 wherein said spacer member comprises a mesh of woven polymeric or metal fibers.

33. A metal/air depolarized cell comprising an anode can and a cathode can, an anode material comprising zinc and alkaline electrolyte within said anode can, and a cathode assembly comprising cathode material within said cathode can; wherein the cathode can comprises an open end and opposing closed end and integral side wall therebetween; said cathode can closed end having an inside surface facing the cell interior and outside surface facing the external environment; wherein said anode can comprises an open end and opposing closed end and integral side wall therebetween; wherein the open end of the anode can resides within the open end of the cathode can with at least a portion of the cathode can side wall overlapping at least a portion of the anode can side wall with electrically insulating material between said overlapping wall portions; wherein there is a plurality of air holes running through the closed end of said cathode can, and the cathode assembly resides within the cathode can in proximity to the closed end of the cathode can adjacent said air holes; wherein there is an air inlet region between the inside surface of said closed end of the cathode can and the cathode assembly; wherein there is at least one projection of material emanating from the closed end of the cathode can and protruding into the air inlet region; wherein said projection of material has side walls terminating in an apex; wherein said side walls and apex penetrate into the air inlet region within the cathode can.

34. The cell of claim 33 wherein said projection of material protrudes integrally from said closed end of the cathode can into said air inlet region.

35. The cell of claim 34 wherein there is a plurality of said projections of material and wherein channels of unoccupied space within said air inlet region are formed by channels of space between walls of adjacent projections of material and between walls of said projections of material and the cathode can, wherein said channels of unoccupied space underlie a plurality of the air holes in the cathode can.

36. The cell of claim 33 wherein said projection of material comprises a nodule of material adhesively secured to the inside surface of said closed end of the cathode can, wherein said nodule of material has side walls and an apex penetrating into the air inlet region within the cathode can.

37. The cell of claim 36 wherein there is a plurality of said projections of material and wherein channels of unoccupied space within said air inlet region are formed by channels of space between walls of adjacent projections of material and between walls of said projections of material and the cathode can, wherein said channels of unoccupied space underlie a plurality of the air holes in the cathode can.

38. The cell of claim 33 wherein the outside surface of the closed end of the cathode can has therein a plurality of integral indentations forming a plurality of said projections of material; wherein each of said indentations has side walls terminating in an apex; wherein said side walls and apex penetrate into the air inlet region within the cathode can.

39. The cell of claim 38 wherein channels of unoccupied space within said air inlet region are formed by channels of space between walls of adjacent indentations and between walls of the indentations and the cathode can, wherein said channels of unoccupied space underlie a plurality of the air holes in the cathode can.

40. The cell of claim 39 wherein said channels of unoccupied space underlie a majority of the air holes in the cathode can.

41. The cell of claim 39 wherein said channels of unoccupied space underlying the air holes run between the air holes and the cathode assembly.

42. The cell of claim 41 wherein said channels of unoccupied space run perpendicularly and continuously between at least the majority of said individual air holes and the cathode assembly.

43. The cell of claim 39 wherein said channels of unoccupied space have a diameter which is at least 2 times the diameter of the individual air holes which they underlie.

44. The cell of claim 43 wherein said channels of unoccupied space comprise between about 10 and 90 percent of the available space within said air inlet region of the cathode can, said available space is as measured before said spacer member is inserted therein.

45. The cell of claim 43 wherein said channels of unoccupied space comprise between about 50 and 90 percent of the available space within said air inlet region of the cathode can, said available space is as measured before said spacer member is inserted therein.

46. The cell of claim 33 wherein said air holes have a diameter between about 7 mil and 15 mil (0.178 mm and 0.381 mm).

47. The cell of claim 33 wherein said cell has disk-like cylindrical shape having diameter between about 4 and 20 mm and a height between about 2 and 9 mm.

48. The cell of claim 33 wherein the anode can and cathode can wall thicknesses are thin between about 2.0 and 5 mils (0.0508 and 0.127 mm).

49. The cell of claim 33 wherein said cathode assembly has a substantially flat surface facing said closed end of the cathode can.

50. The cell of claim 49 wherein said indentations form a spacer member within the air inlet region of the cathode can and said spacer member prevents the cathode assembly from bending into the air inlet region.
